(19) United States
(12) Patent Application Publication
(10) Pub. No.: US 2005/0254158 A1
(43) Pub. Date: Nov. 17, 2005

(54) ESD protection for differential mode magnetic transducer

(76) Inventors: Stephen C. Kuehne, Rosemount, MN (US); James P. Howley, Broomfield, CO (US); Che Choi Leung, Bethlehem Township, PA (US); David W. Kelly, Lino Lakes, MN (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/955,237

(22) Filed: Sep. 30, 2004

Related U.S. Application Data
(60) Provisional application No. 60/570,556, filed on May 13, 2004.

(51) Int. Cl. G11B 5/02

(52) U.S. Cl. 360/67

(57) ABSTRACT

Use of a depletion mode MOSFET to protect differential terminals of a disk drive read head transducer from an electrostatic discharge event, wherein MOSFET source and drain terminals are connected to the differential terminals. The MOSFET is normally “on” such that a conductive path is provided between the differential signal terminals during assembly of the transducer into a disk drive data storage system and during periods when the transducer is inoperative. The conductive path, limits the differential voltage between the terminals that is generated by a current pulse of an ESD event. The MOSFET is gated off during operation of the disk drive to permit a differential read signal, representing the read data bits, to be developed between the differential terminals.

This invention claims the benefit of the provisional patent application filed on May 13, 2004, entitled “ESD Protection for Differential Mode Magnetic Transducer for Data Storage System Using Depletion Mode MOSFET”, and assigned application No. 60/570,556.

### FIELD OF THE INVENTION

The present invention relates to an apparatus and a method for providing electrostatic discharge protection for a magnetic transducer, and more particularly to an apparatus and method employing a depletion mode metal-oxide semiconductor field effect transistor (MOSFET) for providing electrostatic protection for the magnetic transducer.

### BACKGROUND OF THE INVENTION

Disk drives are widely accepted as a cost effective data storage system for a computer or other data processing device. As shown in FIG. 1, a disk drive 10 comprises a magnetic recording medium, in the form of a disk or platter 12 having a hub 13 and a magnetic read/write transducer 14, commonly referred to as a read/write head. The read/write head 14 is attached to, or formed integrally with, a suspension arm 15 suspended over the disk 12 and affixed to a rotary actuator arm 16. A structural arm 18, fixed to a platform 20 of the disk drive 10, is pivotably connected to the actuator arm 16 at a pivot joint 22. A voice coil motor 24 drives the actuator arm 16 to position the head 14 over a selected position on the disk 12.

As the disk 12 is rotated by a spindle motor (not shown) at an operating speed, the moving air generated by the rotating disk, in conjunction with the physical features of the suspension arm 15, lifts the read/write head 14 away from the platter 12, allowing the head to glide or fly on a cushion of air slightly above a surface of the disk 12. The flying height of the read/write head over the disk surface is typically less than a micron.

A preamplifier 30, electrically connected to the head 14 by flexible conductive leads 32, amplifies signals generated in the head 14 during a read operation to improve a signal-to-noise ratio of the signal. In addition to the preamplifier 30, an arm electronics module may include circuits that switch the head function between read and write operations, and write drivers that supply write currents to the head 14 during the write function to store input data on the disk 12. Thus the configuration and components of the module may vary according to the system design, as will be understood by persons familiar with such technology. The module may be mounted anywhere in the disk drive 10, however it is advantageous to dispose the preamplifier 30 proximate the head 14 to minimize signal losses and noise induced into the head signals. A preferred location for mounting the module includes mounting on a side surface of the structural arm 18 as shown in FIG. 1.

Data bits are stored on the platter 12 in sectors 40 on concentric tracks 42. Typically, a sector contains a fixed number of bytes (for example, 256 or 512). A plurality of sectors are commonly grouped into a cluster.

FIG. 2 illustrates the magnetic transducer or head 14, typically comprising a write head 14A for writing magnetic transitions to the disk 12 and a read head 14B for reading the magnetic transitions in the disk 12. The disk 12 comprises a substrate 50 and a thin film 52, disposed thereover. Current flow through the write head 14A alters magnetic domains of ferromagnetic material in the thin film 52 for storing the data.

In other embodiments, the write head 14A and the read head 14B operate with other storage media (not shown) comprising a rigid magnetic disk, a flexible magnetic disk, magnetic tape, and a magneto-optical disk.

In a read mode, an output signal is produced at signal terminals 54A and 54B and supplied to the preamplifier 30 via the conductive leads 32. The signal comprises a relatively small AC (alternating current) voltage imposed on a DC (direct current) bias voltage of about 0-3V, which is supplied to the head 14B by the arm electronics module. As the magnetic domains representing the stored data bits pass under the read head 14B a resistance of magneto-resistive material in the read head is altered, producing the AC component of the output signal.

The susceptibility of certain integrated circuits to electrostatic discharge events is well known. An ESD event occurs when a charged object, e.g., equipment used to install the integrated circuit into a printed circuit board, is brought into proximity to an integrated circuit pin that is at a different potential than the charged object. The resulting static discharge between the object and the pin may generate a current exceeding one ampere during a period of less than 200 nanoseconds. The magnitude of the peak current and the wave shape of the discharge depend on the effective resistance, capacitance and inductance of the system and the amount of charge present on the surfaces before the static discharge. The ESD event can destroy the integrated circuit by damaging the silicon, silicon dioxide or the metal interconnects in the integrated circuit. It is common practice to include extra components in the integrated circuit to direct the ESD current away from sensitive integrated circuit components.

A disk drive read head typically comprises a magneto-resistive (MR) sensor or an inductive sensor. The MR sensor is more frequently used, especially in high-density disk drives, because the MR sensor provides a larger output signal than the inductive sensor. Thus the MR sensor provides a higher signal-to-noise ratio in the read mode and permits a higher area storage density for the disk drive 10. However, when exposed to an ESD event or an electrical overstress (EOS) condition (i.e., an input voltage or current greater than expected under normal operating conditions), the MR sensor tends to be more susceptible to damage than its inductive counterpart because of the relatively small physical size of the MR sensing material. For example, an MR read sensor used for extremely high recording densities has a typical cross-section of 100 Angstroms by 1.0 micrometer. An ESD of only a few volts across such a small resistor is sufficient to produce currents capable of severely damaging or destroying the MR read head.

Read head damage due to ESD/EOS event has been observed during manufacturing of disk drives. For example, if an electrostatic charge develops on a plastic component used during assembly, and the charged component comes in contact with the head or the signal terminals 54A and 54B of FIG. 2, an ESD event can occur. An ESD event is especially likely to occur during that part of the manufacturing process when the terminals 54A and 54B are exposed, i.e., before the head is connected to the preamplifier 30. The current generated by the electrostatic discharge can damage or even destroy the MR read head sensor 14B. An ESD event (or a series of small ESD events) may damage a magneto-resistive head by degrading the magneto-resistive element, changing the resistance of the MR head leading to errors during data read operations. A relatively large ESD event may cause melting or evaporation of the MR head 14B, including its magneto-resistive element.

To prevent such damage, special head handling procedures are employed during disk drive assembly to minimize the potential for electrostatic damage to the head 14. For example, in a manufacturing process employing a rubber or plastic conveyor belt for transporting the head and associated components between manufacturing operations, ionized gas is dispersed over the conveyor belt to discharge any electrostatic charges generated in the belt material.

The read head 14B typically operates as a differential device, i.e., during a read operation the head produces a differential voltage, representing the read data bits, across the signal terminals 54A and 54B. The read head 14B is thus extremely sensitive to ESD damage caused by a high differential voltage applied between the signal terminals 54A and 54B. A differential voltage as low as 0.5 volts can damage a modern MR head.

One prior art technique for providing ESD protection for the differential signal terminals 54A and 54B (connected respectively to conductive leads 32A and 32B of the flexible conductive leads 32) is illustrated in FIG. 3. Diodes 80 and 82 are connected back-to-back (i.e., a cathode of a first diode is connected to anode of a second diode and an anode of the first diode is connected to a cathode of the second diode; also referred to as an anti-parallel configuration) to short the signal terminals 54A and 54B together in response to application of either a negative or a positive ESD voltage to either the terminal 54A or 54B. The diodes 80 and 82 provide adequate protection if the head 14B can withstand a differential voltage greater than a diode turn-on voltage of about 0.7V, i.e., the voltage at which the diode becomes conductive. Unfortunately, newer generation heads can fail at differential voltages below 0.7V. Although it may be possible to identify diodes fabricated from material such that the turn-on voltage is less than 0.7V, a low turn-on voltage may clip the differential output signal from the head 14B when the diodes are driven into conduction during a read operation.

Another prior art technique as disclosed in U.S. Pat. No. 6,552,879 is illustrated in FIG. 4. A MOSFET 90, connected between the terminals 54A and 54B, is triggered to a conductive state, i.e., a low resistance path between a drain D and a source S, by a static charge sensing circuit 56 that provides a triggering signal to a gate G in response to the ESD voltage. The low resistance path effectively shorts the terminals 54A and 54B, preventing a voltage differential from developing therebetween.

The sensing circuit 56 adds cost and a space penalty to the disk drive 10 and requires a power source for operation. During disk drive assembly, power is not applied to the sensing circuit 56 and thus the circuit cannot function to protect against ESD damage. In other prior art disk drives the sensing circuit 56 is powered by the applied static pulse, but this configuration requires a pulse amplitude larger than about 0.5V, in contravention with the requirement that the discharge protection circuit maintain the differential input voltage at less than about 0.5V.

### BRIEF SUMMARY OF THE INVENTION

The present invention comprises an apparatus having a transducer with first and second differential output terminals. A depletion mode MOSFET having a source/drain path connected between the first and the second differential output terminals provides a conductive path between the first and the second output terminals when the MOSFET is in a first state. A control signal is applied to a gate terminal of the MOSFET for controlling the MOSFET to a second state.

The present invention further comprises a method for controlling a voltage across differential output terminals of a device, comprising controlling a depletion mode MOSFET having a source/drain path connected between the differential output terminals to a first state for providing a conductive path between the first and the second output terminals, and controlling the MOSFET to a second state when the device is operative.

### BRIEF DESCRIPTION OF THE DRAWINGS

The foregoing and other features of the present invention will be apparent from the following more particular description of the invention as illustrated in the accompanying drawings, in which like reference characters refer to the same parts throughout the different figures. The drawings are not necessarily to scale, emphasis instead being placed upon illustrating the principles of the invention.

FIG. 1 illustrates a prior art disk drive to which the teachings of the present invention can be applied.

FIG. 2 is a schematic diagram of a head of the disk drive of FIG. 1.

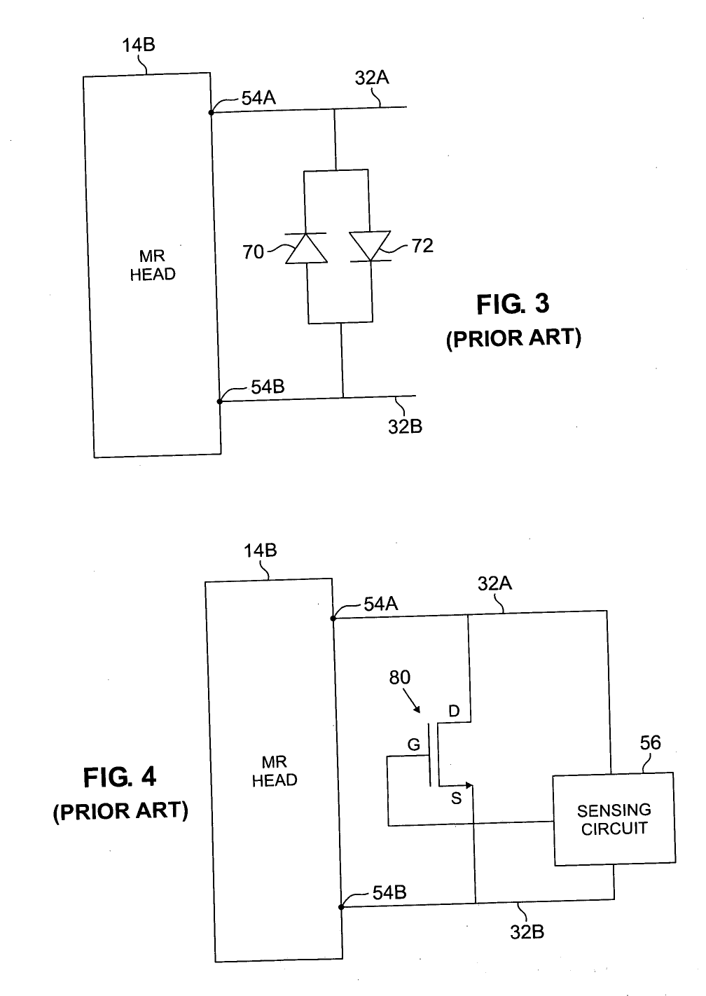

FIGS. 3 and 4 are schematic representations of prior art techniques for protecting the head of FIG. 2 from electrostatic discharge damage.

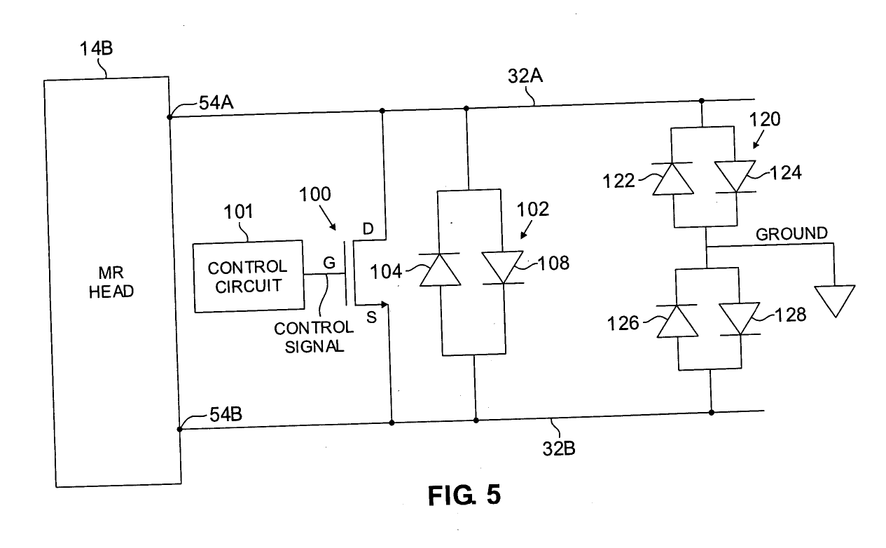

FIGS. 5-7 are schematic representations of techniques for protecting the head of FIG. 2 from electrostatic discharge damage according to the teachings of the present invention.

### DETAILED DESCRIPTION OF THE INVENTION

Before describing in detail the ESD protection method and apparatus according to the present invention, it should be observed that the present invention resides in a novel and non-obvious combination of hardware elements and process steps. Accordingly, these elements have been represented by conventional elements in the drawings and specification, wherein elements and process steps conventionally known in the art are described in lesser detail, and elements and steps pertinent to understanding the invention are described in greater detail.

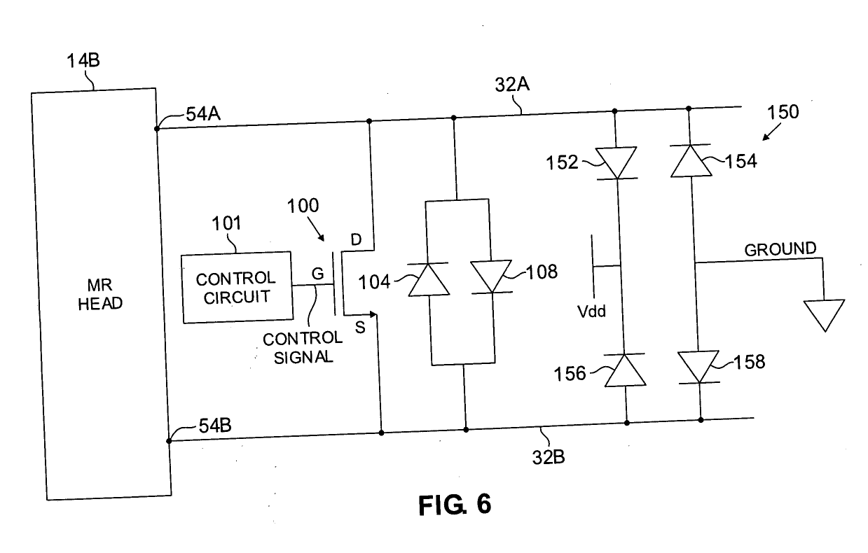

According to the teachings of the present invention, a depletion mode NMOSFET 100 of FIG. 5 is employed to protect against application of a differential voltage across the signal terminals 54A and 54B of the MR head 14B. The depletion mode NMOSFET 100 is a normally closed or conductive device (i.e., with no bias or gate drive supplied, a conductive path is present between a source S and a drain D). During disk drive assembly and periods when the disk drive is off, the NMOSFET maintains a conductive path across the terminals 54A and 54B. During operation of the disk drive 10 a control circuit 101 supplies a control signal to a gate G to switch the NMOSFET 100 to an open or non-conductive state, opening the source-drain path and permitting the MR head 14B to function normally.

In an embodiment in which the control circuit 101 is included within the preamplifier 30, the NMOSFET control signal is generated by the control circuit 101 in response to control signals supplied to the preamplifier 30 to enable the read function. Typically, these control signals comprise logic signals with logic states at ground and 3.3 volts. A level translator responsive to the logic signals produces the NMOSFET control signal with logic states at ground and −3 volts. Application of the −3 volt logic level to the gate G of the depletion mode NMOSFET device disables the NMOSFET; application of a signal having a logic level near ground drives the NMOSFET into conduction.

The conductive path provided by the depletion mode NMOSFET 100 ensures that the differential voltage across the MR head terminals 54A and 54B is maintained at a safe level during an ESD discharge. Selection of a depletion mode NMOSFET having appropriate characteristics can limit the voltage across the terminals 54A and 54B to a value below the maximum allowable differential voltage. For example, a NMOSFET channel width can be adjusted to trade off bandwidth and ESD protection margin. A wider channel MOSFET exhibits a lower impedance path (i.e., high conductance path) between the drain D and the source S, providing an additional ESD protection margin, but in the non-conductive state may introduce parasitic capacitance that can limit bandwidth response to read signals at the signal terminals 54A and 54B during normal operation.

The depletion mode NMOSFET 100, connected as shown in FIG. 5, is in the conductive state even when no power is supplied to the NMOSFET. Without the application of power, all internal nodes of the MOSFET tend to leak toward ground, causing the depletion mode MOSFET to conduct. Thus, according to the teachings of the present invention the prior art charge sensing circuit is not required, and the disadvantages associated with its use are avoided.

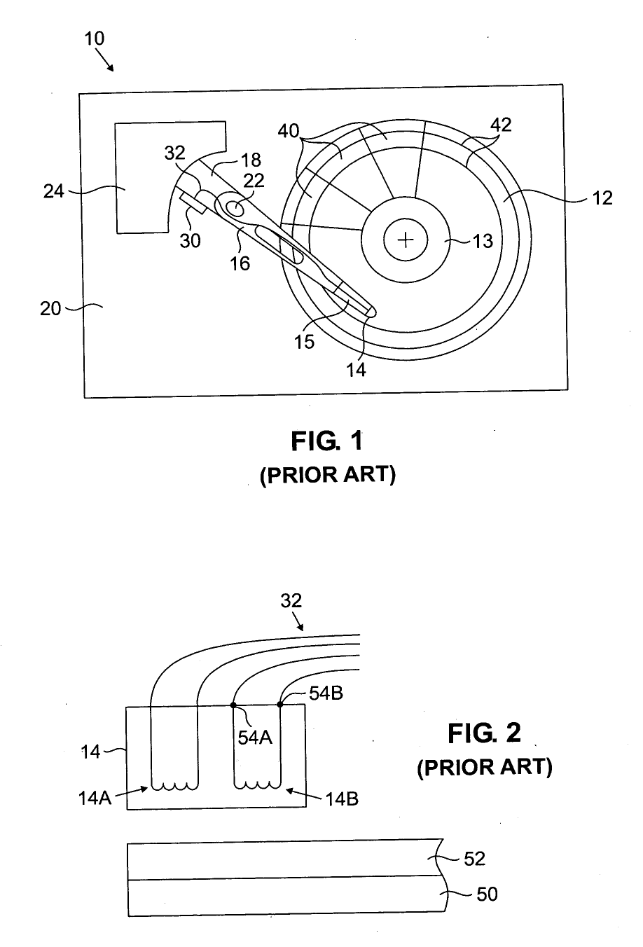

Unlike the prior art diode bridge of FIG. 1, which has a turn-on voltage of between about 0.5V to 0.7V, the normally closed MOSFET 100 provides a conductive path across the terminals 54A and 54B even at zero bias. As noted above, the conductance can be balanced against the parasitic capacitance of the NMOSFET as desired for a specific application. For example, a disk drive manufacturer with lower bandwidth requirements for read signals, but less control of its assembly environment, may choose to use a larger depletion mode MOSFET to reduce the resistance in the source/drain path. Another disk drive manufacturer more concerned with read signal bandwidth and confident about ESD protection measures in its assembly operations, can use a smaller depletion mode MOSFET.

In one embodiment, the depletion mode NMOSFET 100 is fabricated in the preamplifier 30 connected to the head 14B by the conductive leads 32. Once the head 14B and the preamplifier 30 are connected during the disk drive assembly process, the head 14B is protected against ESD discharges by the normally closed NMOSFET 100. In another embodiment, the NMOSFET 100 is incorporated into the head 14B.

Although not required according to the teachings of the present invention, in one embodiment a diode bridge 102, comprising diodes 104 and 108 connected back-to-back as shown in FIG. 5 (also referred to as anti-parallel connected diodes), is connected in parallel with a source/drain (S/D) path of the depletion mode MOSFET 100. In one embodiment, the diode bridge 102 is co-located with the NMOSFET 100. The diode bridge 102 protects against certain larger ESD events that can damage the NMOSFET 100, and other components of the integrated circuit preamplifier 30 (See FIG. 1), such as MOSFET'S, bipolar transistors, resistors and capacitors. These larger ESD events can occur during handling and testing of the preamplifier 30, prior to incorporation into the disk drive head 10.

In yet another embodiment, a diode bridge 120, comprising diodes 122, 124, 126 and 128 connected as shown in FIG. 5, limits a positive and a negative voltage that can be applied to one or both of the terminals 54A and 54B with respect to ground, such as a voltage developed between one of the terminals 54A and 54B and ground during an ESD event. In particular, the diode bridge 120 limits the voltage on the terminals 54A and 54B to one diode voltage drop (i.e., about 0.5V to 0.7V) with respect to ground. Positive ESD voltages are limited by driving the diodes 124 and 126 into conduction; negative voltages are limited by driving the diodes 122 and 128 into conduction. The diode bridge 120 also protects components in the integrated circuit preamplifier 30 that are connected to the conductive leads 32A and 32B.

FIG. 6 illustrates a diode bridge 150 (comprising diodes 152, 154, 156 and 158) that protects the terminals 54A and 54B from damage by a negative voltage below ground (by causing the diodes 154 and/or 158 to turn on) and a positive voltage above Vdd (by causing the diodes 152 and/or 156 to turn on). The diodes 154 and 158 clamp the voltage at the terminals 54A and 54B to one diode voltage drop with respect to ground, and the diodes 152 and 156 clamp the voltage to one diode voltage drop with respect to Vdd. Although any value can be selected for Vdd, preferably Vdd is a voltage supplied to the integrated circuit preamplifier 30 to drive the circuits thereof.

A control signal is supplied to the gate G of the depletion mode NMOSFET 100 to switch the depletion mode MOSFET to an open or non-conductive state during normal operation of the hard disk drive. One possible control mechanism is shown in FIG. 7 for a depletion mode NMOSFET 160 formed in a triple-well substrate of the preamplifier integrated circuit 30, such that the application of a negative voltage switches the depletion mode NMOSFET 160 open or non-conductive. When the power supply collapses, the NMOSFET 160 is in a closed state.

A gate G of the NMOSFET 160 is driven by an inverter 200 that supplies a voltage Vee (a negative voltage in this example) to the gate G during normal operation of the read head 14B to turn the NMOSFET 160 off. A positive power supply terminal 202 of the inverter 200 is connected to ground, and a negative power supply terminal 204 is connected to Vee. When an input terminal 206 is connected to Vee an output terminal 210 is at ground. When the input terminal 206 is connected to ground the output terminal 210 is at Vee. Thus application of a voltage to the input terminal 206 controls the state of the NMOSFET 160. As is known in the art, to turn off a depletion mode NMOSFET, both the gate to source voltage and the gate to drain voltage must be negative. Since the signal terminals 54A and 54B are close to ground potential, application of a negative voltage Vee to the gate G turns off the depletion mode NMOSFET 160.

In an embodiment where the logic level states of the inverter 200 are not acceptable for driving the NMOSFET 160, a level translator is interposed between the inverter 200 and the gate G for providing an appropriate drive signal for the MOSFET 160 in response to the output logic level of the inverter 200.

Although described in conjunction with a depletion mode NMOSFET, the teachings of the present invention can be employed with other normally closed semiconductor devices that can be gated open when data is read from the disk. Such other normally closed devices are connected to provide a conductive path between the differential signal terminals 54A and 54B to avoid the ESD/EOS event when the head 14B is not in an operating state, and controllable to open the conductive path when it is desired to read data from the disk drive or otherwise operate the transducer. For example, the present invention can be practiced using a depletion mode PMOSFET or a JFET (junction field effect transistor).

Other types of transducers and sensors that employ a differential output signal (e.g., an accelerometer for controlling deployment of an automobile air bag) can benefit from use of a depletion mode MOSFET or protecting against ESD/EOS events as described herein.

While the present invention has been described with reference to preferred embodiments, it will be understood by those skilled in the art that various changes may be made and equivalent elements may be substituted for the elements thereof without departing from the scope of the present invention. The scope of the present invention further includes any combination of elements from the various embodiments set forth herein. In addition, modifications may be made to adapt a particular situation to the teachings of the present invention without departing from its essential scope. For example, the teachings of the present invention are not limited to use of a depletion mode NMOSFET in conjunction with a read head of a disk drive data storage system, but can also be applied to the use of depletion MOSFETS with other differential output transducer devices. Therefore, it is intended that the invention not be limited to the particular embodiments disclosed, but that the invention will include all embodiments falling within the scope of the appended claims.

1. An apparatus comprising:
a magneto resistive transducer having first and second differential output terminals;
a depletion mode MOSFET having a source/drain path connected between the first and the second differential output terminals, wherein the source/drain path provides a conductive path between the first and the second output terminals when the MOSFET is in a first state; and
a control circuit for producing a control signal for application to a gate terminal of the MOSFET for controlling the MOSFET to a second state.

2. The apparatus of claim 1 wherein the MOSFET is placed in the second state when it is desired to operate the transducer.

3. The apparatus of claim 1 wherein the control signal comprises a negative voltage.

4. The apparatus of claim 1 wherein the magneto resistive transducer comprises a magnetoresistive head for use with a disk drive data storage system.

5. The apparatus of claim 1 wherein the MOSFET is selected from among a depletion mode NMOSFET, a depletion mode PMOSFET and a depletion mode JFET.

6. The apparatus of claim 1 further comprising a pair of anti-parallel diodes disposed across the first and the second differential output terminals.

7. The apparatus of claim 1 further comprising a first pair of anti-parallel diodes connected between the first differential output terminal and ground, and a second pair of anti-parallel diodes connected between the second differential output terminal and ground.

8. The apparatus of claim 1 further comprising a first diode having a cathode connected to the first differential output terminal and an anode connected to ground, and a second diode having a cathode connected to the second differential output terminal and an anode connected to ground.

9. The apparatus of claim 1 further comprising a first diode having an anode connected to the first differential output terminal and a cathode responsive to a DC voltage, and a second diode having an anode connected to the second differential output terminal and a cathode responsive to a DC voltage.

10. The apparatus of claim 1 further comprising a preamplifier integrated circuit connected to the first and the second differential output terminals, wherein the MOSFET is disposed in the preamplifier integrated circuit.

11. The apparatus of claim 1 wherein the transducer comprises a magnetoresistive head for reading data from a disk drive data storage system, and wherein the control signal switches the MOSFET to the second state in response to operation of the preamplifier for reading data.

12. The apparatus of claim 1 wherein during an ESD or EOS event the ESD or EOS discharge current flows through the conductive path.

13. The apparatus of claim 1 wherein when the MOSFET is in the first state, a voltage between the first and the second output terminals is limited according to a conductivity of the source/drain path.

14. The apparatus of claim 1 wherein a voltage between the first and the second output terminals is responsive to a channel size of the MOSFET.

15. The apparatus of claim 1 wherein the control circuit comprises an inverter for producing the control signal, wherein a positive power supply terminal of the inverter is connected to ground and a ground terminal of the inverter is connected to a negative voltage.

16. The apparatus of claim 1 wherein the second state comprises a substantially open source/drain path.

17. A method for controlling a voltage across differential output terminals of a device, comprising:
controlling a depletion mode MOSFET having a source/drain path connected between the differential output terminals to a first state for providing a conductive path between the first and the second output terminals; and
controlling the MOSFET to a second state when the device is operative.

18. The method of claim 17 further comprising supplying a voltage to a gate terminal of the MOSFET for controlling the MOSFET to the first state or the second state.

19. A preamplifier for a data storage system connectable to a magneto resistive transducer for reading data from a data storage element of the data storage system, wherein the magneto resistive transducer comprises first and second differential output terminals, the preamplifier comprising:
a depletion mode MOSFET having a source/drain path connected between the first and the second differential output terminals, wherein the source/drain path provides a conductive path between the first and the second output terminals when the MOSFET is in a first state; and
a control circuit for producing a control signal for application to a gate terminal of the MOSFET for controlling the MOSFET to a second state.

20. The preamplifier of claim 19 wherein the MOSFET is placed in the second state when it is desired to operate the transducer.

21. The preamplifier of claim 19 wherein the control signal comprises a negative voltage.

22. The preamplifier of claim 19 wherein the MOSFET is selected from among a depletion mode NMOSFET, a depletion mode PMOSFET and a depletion mode JFET.

23. The preamplifier of claim 19 further comprising a pair of anti-parallel diodes disposed across the first and the second differential output terminals.

24. The preamplifier of claim 19 further comprising a first pair of anti-parallel diodes connected between the first differential output terminal and ground, and a second pair of anti-parallel diodes connected between the second differential output terminal and ground.

25. The preamplifier of claim 19 further comprising a first diode having a cathode connected to the first differential output terminal and an anode connected to ground, and a second diode having a cathode connected to the second differential output terminal and an anode connected to ground.

26. The preamplifier of claim 19 further comprising a first diode having an anode connected to the first differential output terminal and a cathode responsive to a DC voltage, and a second diode having an anode connected to the second differential output terminal and a cathode responsive to a DC voltage.

27. The preamplifier of claim 19 wherein during an ESD or EOS event the ESD or EOS discharge current flows through the conductive path.

28. The preamplifier of claim 19 wherein when the MOSFET is in the first state, a voltage between the first and the second output terminals is limited according to a conductivity of the source/drain path.

29. The preamplifier of claim 19 wherein a voltage between the first and the second output terminals is responsive to a channel size of the MOSFET.

30. The preamplifier of claim 19 wherein the control circuit comprises an inverter for producing the control signal, wherein a positive power supply terminal of the inverter is connected to ground and a ground terminal of the inverter is connected to a negative voltage.
